(19) United States
(12) Patent Application Publication
(10) Pub. No.: US 2026/0357742 A1
(43) Pub. Date: Nov. 12, 2026

(54) Rotary Engine with Axially Symmetric Ring Gears

(71) Applicant: LiquidPiston, Inc., Bloomfield, CT (US)

(72) Inventors: Alexander Shkolnik, Wilmington, MA (US); Nikolay Shkolnik, West Hartford, CT (US); Alexander Kopache, Simsbury, CT (US); Mark Nickerson, Falmouth, ME (US); Saad Ahmed, West Hartford, CT (US); Kyle Becker, Arlington, MA (US); Adam Spitulnik, Hartford, CT (US); Konstantin Mikhailov, Pasadena, MD (US)

(21) Appl. No.: 19/102,038

(22) PCT Filed: Jun. 23, 2023
(86) PCT No.: PCT/US23/68948

§ 371 Date: Feb. 7, 2025

Related U.S. Application Data
(60) Provisional application No. 63/400,797, filed on Aug. 25, 2022.

(51) Int. Cl. F02B 55/08

(52) U.S. Cl. CPC F02B 55/08

(57) ABSTRACT

An improved rotary engine having a pair of symmetrically disposed ring gears.

### CROSS-REFERENCE TO RELATED APPLICATION

The present application claims priority from U.S. Provisional Application No. 63/400,797, filed Aug. 25, 2022, the contents of which are hereby incorporated by reference in their entirety.

### GOVERNMENT RIGHTS IN INVENTION

This invention was made with Government support under Agreement No. HR0011-16-9-0009, awarded by DARPA. The Government has certain rights in the invention.

### TECHNICAL FIELD

The present invention relates to rotary engines having axially symmetric ring gears for load distribution during operation.

### BACKGROUND ART

Wankel-type rotary engines employ a single ring gear and pinion gear to control the angular position of the rotor with respect to the housing during operation. However, high compression engines, such as diesel engines, generate much higher dynamic and gas loads than earlier generations of rotary gasoline engines and a single ring gear and pinion gear can be insufficient for their operation.

### SUMMARY OF THE EMBODIMENTS

In accordance with one embodiment of the invention, an improved pistonless rotary engine of the type including (i) a rotor having a central axis of rotation and first and second axial faces, (ii) a housing having a plurality of working chambers, (iii) a pair of side covers axially disposed on first and second sides of the rotor and coupled to the housing, and (iv) an output shaft coupled to the rotor, wherein the improvement comprises a pinion gear disposed around the output shaft to support rotation with respect to the output shaft and running through the central axis of the rotor and rigidly coupled to the rotor, the pinion gear having first and second segments extending axially beyond the first and second axial faces, respectively, of the rotor, as well as a plurality of teeth circumferentially disposed around its outer radial surface, and a pair of ring gears, symmetrically disposed on opposing sides of the rotor, each ring gear affixed to an inside face of one of the side covers, each of the ring gears having a plurality of teeth circumferentially disposed around an inner radial surface of each of the ring gears, and configured to engage with the teeth of a corresponding one of the pinion gear segments.

In some embodiments, the teeth of the first and second segments of the pinion gear are crowned. In some embodiments, the teeth of each of the ring gears are crowned.

In some embodiments, each of the ring gears includes a flexible thin continuous rim around its outer circumference.

In some embodiments, the pinion gear is coupled to the output shaft by a first bearing. The first bearing may be a hydrodynamic bearing.

In some embodiments, each ring gear is affixed to the inside face of one of the side covers by a spring pin. In some embodiments, the output shaft extends through each of the pair of side covers.

In some embodiments, each of the pair of side covers is coupled to the output shaft by a second bearing. In some embodiments, the second bearing is a hydrodynamic bearing.

In some embodiments, an inner axial face of each of the ring gears comprises a groove and a series of pad cutouts disposed circumferentially around at least a portion of a circumference of the inner axial face of each of the ring gears. In some embodiments, the groove and series of pad cutouts are disposed circumferentially around an entire circumference of the inner axial face of each of the ring gears.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The foregoing features of embodiments will be more readily understood by reference to the following detailed description, taken with reference to the accompanying drawings, in which:

FIG. 1 is a photograph of a rotary engine mounted on brackets, in accordance with an embodiment of the present invention.

FIG. 2 is an exploded view of rotary engine components, in accordance with an embodiment of the present invention.

FIG. 3 is a perspective view of an assembly of the rotary engine components of FIG. 2, in accordance with an embodiment of the present invention.

FIG. 4 is a photograph of the rotary engine of FIG. 1 without a side cover, in accordance with an embodiment of the present invention.

FIG. 5 is a perspective view of selected components, in their normal configuration, of a rotary engine having a pair of ring gears symmetrically disposed on opposing sides of a rotor (not shown), in accordance with an embodiment of the present invention.

FIG. 6 illustrates a misalignment between a pinion gear and two ring gears, evidenced by the lack of symmetry of the two ring gears, in accordance with an embodiment of the present invention.

FIG. 7A shows a vertical misalignment between a pinion gear and a ring gear, in accordance with an embodiment of the present invention. FIG. 7B shows a horizontal misalignment between a pinion gear and a ring gear, in accordance with an embodiment of the present invention. FIG. 7C shows a rotational misalignment between a pinion gear and a ring gear, in accordance with an embodiment of the present invention.

FIG. 8 is a pinion gear with crowning, in accordance with an embodiment of the present invention.

FIG. 9 is a ring gear with crowning, in accordance with an embodiment of the present invention.

FIG. 10A is a ring gear having a flexible thin continuous rim around its outer circumference, in accordance with an embodiment of the present invention. FIG. 10B is a perspective view of a portion of the ring gear of FIG. 10B, in accordance with an embodiment of the present invention.

FIG. 11 is a perspective view of a rotary engine (with side covers and housing removed) from one side of a rotor, the rotor being rigidly fixed to a pinion gear, the pinion gear being coupled to an output shaft by a bearing, for example, a hydrodynamic bearing, in accordance with an embodiment of the present invention. The pinion gear runs through the central axis of the rotor and has first and second segments extending axially beyond the axial faces of the rotor, each segment engaging a corresponding ring gear.

FIG. 12A is a cross section of the rotary engine of FIG. 1 and shows an oil path through the output shaft, in accordance with an embodiment of the present invention. FIG. 12B shows an engine cross section and bearing layout, in accordance with an embodiment of the present invention.

### DETAILED DESCRIPTION OF SPECIFIC EMBODIMENTS

Definitions. As used in this description and the accompanying claims, the following terms shall have the meanings indicated, unless the context otherwise requires:

“Rotary engine” and “pistonless rotary engine” are used interchangeably herein and mean a rotary engine that includes no pistons.

A “compliant” coupling of components of a rotary engine in accordance with embodiments of the present invention means a coupling providing relative flexibility between the components

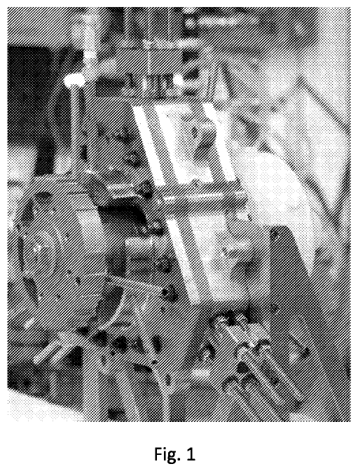

FIG. 1 is a photograph of a rotary engine mounted on brackets in accordance with embodiments of the invention. In some embodiments, rotary engines described herein include, but are not limited to, engines and aspects of engines disclosed in U.S. Pat. Nos. 8,863,724; 8,365,699; 8,863,723; 9,353,623; 9,382,851; 9,528,435; 9,644,570; 9,810,068; 10,196,970; 10,125,675; 10,221,690; and 11,149,547, the disclosure of each which is incorporated by reference herein in its entirety.

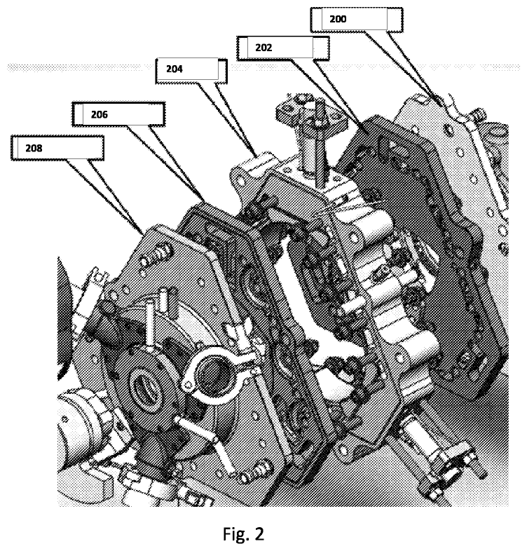

FIG. 2 is an exploded view of rotary engine components, in accordance with embodiments of the invention, including a first side cover, comprising end plate 200 and front plate 202, housing 204, and a second side cover, comprising end plate 208 and back plate 206.

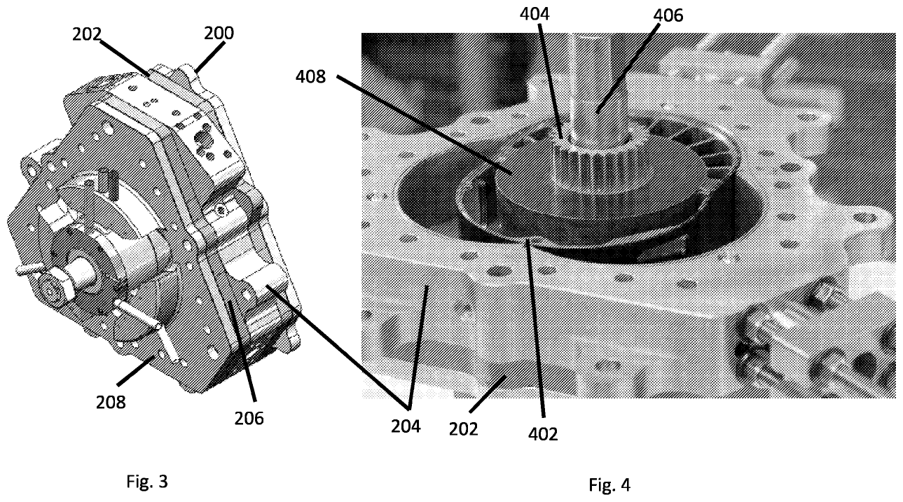

FIG. 3 is a perspective view of an assembly of the rotary engine components of FIG. 2, in accordance with embodiments of the invention.

FIG. 4 is a photograph of the rotary engine of FIG. 1 without a side cover, revealing, within housing 204, rotor 402 with attached pinion gear 404, output shaft 406, and rotor thrust surface 408, in accordance with embodiments of the invention. Pinion gear 404 includes a plurality of teeth circumferentially disposed around its outer radial surface, and is rigidly fixed to rotor 402. Here, the rotor forms three separate working chambers defined by housing 204, front plate 202, back plate 206 (not shown), seals (not shown), and rotor 402 itself. During operation, the rotor nutates, i.e., moves with its center along a circle defined by the shaft's eccentricity and simultaneously rotates around its center, causing compression and allowing expansion of gases within the working chambers.

In order to avoid contact between rotor 402 and housing 204 during operation, a rotary engine requires gearing to ensure that the rotor spins in the opposite direction of the shaft eccentric, with ½ of the shaft speed. For example, in Wankel-type rotary engines, a single ring gear and pinion gear are sufficient to control the angular position of the rotor with respect to the housing. However, compression ignited (CI) diesel engines have much higher loads than earlier generations of rotary gasoline engines, and in various embodiments benefit from more comprehensive gearing.

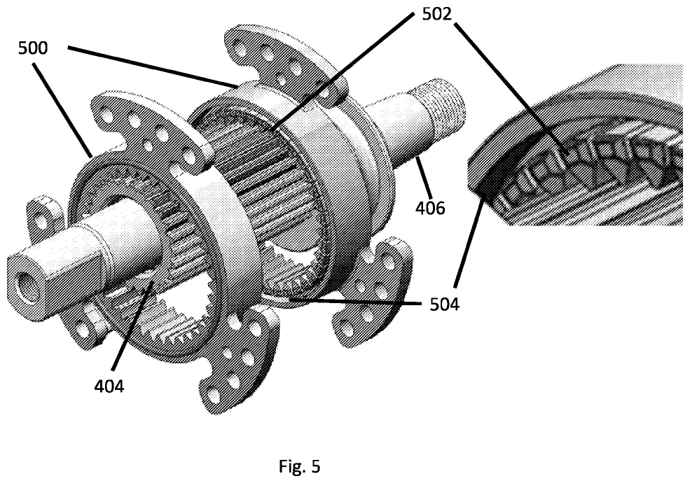

FIG. 5 is a perspective view of selected components, in their normal configuration, of a rotary engine embodiment having a pair of ring gears 500, symmetrically disposed on opposing sides of a rotor (not shown), to control the angular position of the rotor, in accordance with an embodiment of the present invention. Ring gear 500 includes a plurality of teeth, circumferentially disposed around its inner radial surface, that allow ring gear 500 to engage pinion gear 404. Pinion gear 404 being coupled to output shaft 406, in accordance with embodiments of the invention. In some embodiments, pinion gear 404 is coupled to output shaft 406 by a bearing, for example, a hydrodynamic bearing.

In some embodiments, a hydrodynamic thrust bearing between rotor 402 and ring gear 500 is formed by an oil film between rotor thrust surface 408 and an inner axial face of ring gear 500. Groove 504 and pad cutout(s) 502 on the inner axial face of ring gear 500 facilitate greater compliance by providing increased oil lubrication and flow between rotor thrust surface 408 and the inner axial face of ring gear 500. Groove 504 and a series of pad cutouts are disposed circumferentially around at least a portion of a circumference of the inner axial face of ring gear 500. In some embodiments, groove 504 and series of pad cutouts are disposed circumferentially around an entire circumference of the inner axial face of ring gear 500. In some embodiments, a deeper groove on the inner axial face of the ring gear 500 may be used for mounting a compliant oil ring seal, the oil ring seal also running on the rotor thrust surface 408.

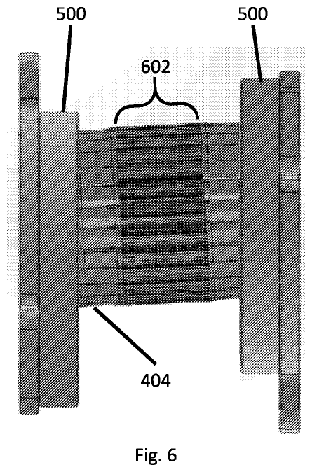

A double ring gear design allows the loads and stresses that would be experienced by a single ring gear to be reduced significantly, as these loads and stresses are shared between both ring gears. While greatly increasing load-carrying capabilities, a double ring gear design may introduce misalignment between pinion gear 404 and the two ring gears 500, as illustrated in FIG. 6 (rotor not shown), evidenced by the lack of symmetry of the two ring gears. Such a misalignment may cause one of the ring gears to take on a greater load than the other one of the ring gears. FIG. 6 further illustrates pinion gear segment 602, which is rigidly affixed to rotor 402 (not shown), in accordance with embodiments of the invention.

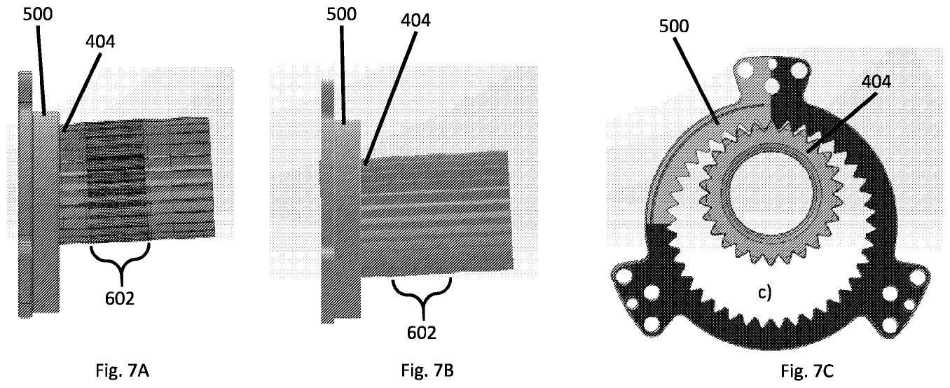

FIG. 7A shows a vertical misalignment between pinion gear 404 and ring gear 500. FIG. 7B shows a horizontal misalignment between pinion gear 404 and ring gear 500. FIG. 7C shows a rotational misalignment between pinion gear 404 and ring gear 500.

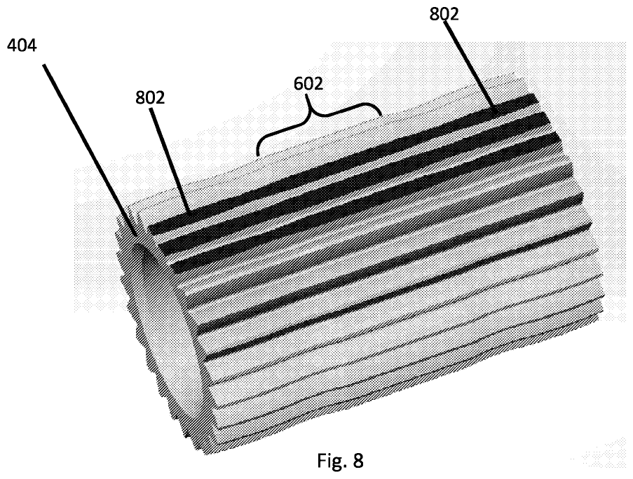

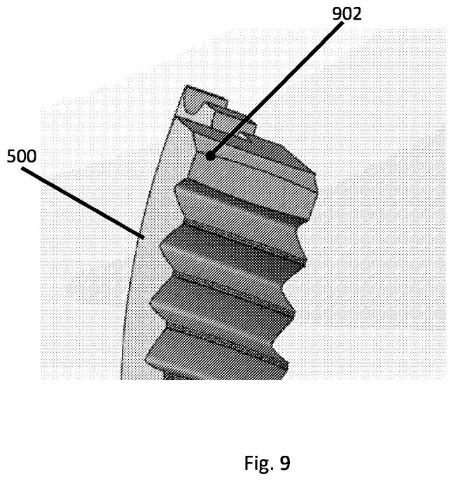

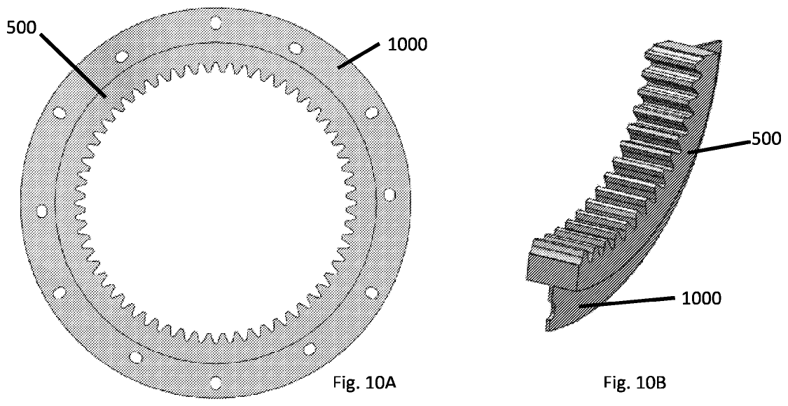

Crowning 802 of pinion gear 404, as shown in FIG. 8 and/or crowning 902 of ring gear 500, as shown in FIG. 9, reduces or eliminates misalignment between pinion gear 404 and ring gear 500. Crowning reduces edge loading for misaligned gears, while compliancy between pinion gear 404 and ring gear 500 (with or without crowning) allows small movement of pinion gear 404 with respect to the double ring gear system, thus distributing the load between the two ring gears more evenly. In some embodiments, compliancy is accomplished by utilizing an oil film to fill gaps in hydrodynamic bearings.

In some embodiments, compliance can be achieved by using a ring gear 500 having a flexible thin continuous rim 1000, as shown in FIG. 10A and FIG. 10B, by which the gear is mounted to a side cover. A ring gear having a thin continuous rim may be mounted to a side cover using compliant washers, e.g., Belleville washers. Flexible thin continuous rim 1000 allows ring gear 500 to become compliant under dynamic and gas loads and, thus, mitigates misalignments. In some embodiments, compliance may be achieved by utilizing a split pinion gear with a compliant element (e.g., a spring), a compliant bearing structure, or a compliant rotor.

FIG. 11 is a perspective view of a rotary engine (with side covers and housing removed) from one side of rotor 402, rotor 402 being rigidly fixed to pinion gear 404, pinion gear 404 being coupled to output shaft 406 by a bearing, for example, a hydrodynamic bearing, in accordance with embodiments of the invention. Pinion gear 404 runs through the central axis of rotor 402 and has first and second segments extending axially beyond the axial faces of the rotor, each segment engaging a corresponding ring gear 500.

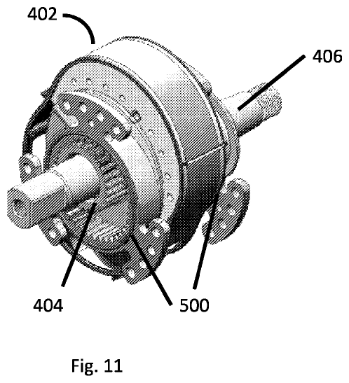

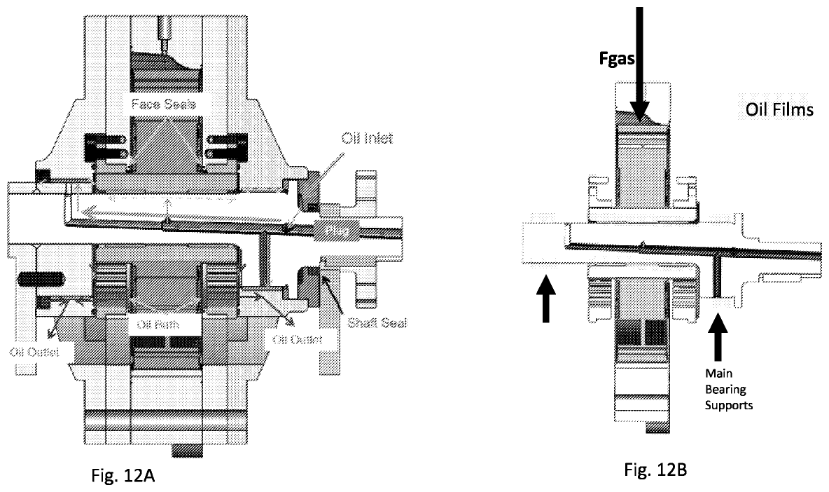

FIGS. 12A and 12B are cross sections of the rotary engine of FIG. 1 in accordance with an embodiment of the present invention, showing oil flow pathways and oil film locations respectively. During operation of a rotary engine, the high temperature of combustion gases causes an increase in the temperature of rotor 402 and housing 204. To prevent coking of lubricating oil film, the rotor and the housing must be cooled. Furthermore, to support gas and inertial loads, the rotor is supported by bearings located in the eccentric shaft, and the eccentric shaft is supported by bearings in the end plates. In a preferred embodiment, these bearings are hydrodynamic, operating with oil as a working fluid. As shown in FIG. 12A and FIG. 12B, oil is supplied internally through a channel in the eccentric output shaft to the hydrodynamic bearings, pinion gear 404, ring gears 500, seals, and the rotor itself. FIG. 12B shows an embodiment of an engine cross section and bearing layout and FIG. 12A shows an embodiment of an oil path through the output shaft.

Various embodiments of the present invention may be characterized by the potential claims listed in the paragraphs following this paragraph (and before the actual claims provided at the end of this application). These potential claims form a part of the written description of this application. Accordingly, subject matter of the following potential claims may be presented as actual claims in later proceedings involving this application or any application claiming priority based on this application. Inclusion of such potential claims should not be construed to mean that the actual claims do not cover the subject matter of the potential claims. Thus, a decision to not present these potential claims in later proceedings should not be construed as a donation of the subject matter to the public.

Without limitation, potential subject matter that may be claimed (prefaced with the letter “P” so as to avoid confusion with the actual claims presented below) includes:
P1. An improved pistonless rotary engine of the type including (i) a rotor having a central axis of rotation and first and second axial faces, (ii) a housing having a plurality of working chambers, (iii) a pair of side covers axially disposed on first and second sides of the rotor and coupled to the housing, and (iv) an output shaft coupled to the rotor, wherein the improvement comprises:
a pinion gear disposed around the output shaft to support rotation with respect to the output shaft and running through the central axis of the rotor and rigidly coupled to the rotor, the pinion gear having first and second segments extending axially beyond the first and second axial faces, respectively, of the rotor, as well as a plurality of teeth circumferentially disposed around its outer radial surface; and
a pair of ring gears, symmetrically disposed on opposing sides of the rotor, each ring gear affixed to an inside face of one of the side covers, each of the ring gears having a plurality of teeth circumferentially disposed around an inner radial surface of each of the ring gears, and configured to engage with the teeth of a corresponding one of the pinion gear segments.
P2. An improved pistonless rotary engine according to claim P1, wherein the teeth of the first and second segments of the pinion gear are crowned.
P3. An improved pistonless rotary engine according to any one of claims P1-P2, wherein the teeth of each of the ring gears are crowned.
P4. An improved pistonless rotary engine according to any one of claim P1-P3, wherein each of the ring gears includes a flexible thin continuous rim around its outer circumference.
P5. An improved pistonless rotary engine according to any one of claims P1-P4, wherein the pinion gear is coupled to the output shaft by a first bearing.
P6. An improved pistonless rotary engine according to claim P5, wherein the first bearing is a hydrodynamic bearing.
P7. An improved pistonless rotary engine according to any one of claims P1-P6, wherein each ring gear is affixed to the inside face of one of the side covers by a spring pin.
P8. An improved pistonless rotary engine according to any one of claims P1-P7, wherein the output shaft extends through each of the pair of side covers.
P9. An improved pistonless rotary engine according to claim P8, wherein each of the pair of side covers is coupled to the output shaft by a second bearing.
P10. An improved pistonless rotary engine according to claim P9, wherein the second bearing is a hydrodynamic bearing.
P11. An improved pistonless rotary engine according to any one of claims P1-P10, wherein an inner axial face of each of the ring gears comprises a groove and a series of pad cutouts disposed circumferentially around at least a portion of a circumference of the inner axial face of each of the ring gears.
P12. An improved pistonless rotary engine according to claim P11, wherein the groove and the series of pad cutouts are disposed circumferentially around an entire circumference of the inner axial face of each of the ring gears.

The embodiments of the invention described above are intended to be merely exemplary; numerous variations and modifications will be apparent to those skilled in the art. All such variations and modifications are intended to be within the scope of the present invention as defined in any appended claims.

1. An improved rotary engine of the type including (i) a rotor having a central axis of rotation and first and second axial faces, (ii) a housing having a plurality of working chambers, (iii) a pair of side covers axially disposed on first and second sides of the rotor and coupled to the housing, and (iv) an output shaft coupled to the rotor, wherein the improvement comprises:
a pinion gear disposed around the output shaft to support rotation with respect to the output shaft and running through the central axis of the rotor and rigidly coupled to the rotor, the pinion gear having first and second segments extending axially beyond the first and second axial faces, respectively, of the rotor, as well as a plurality of teeth circumferentially disposed around its outer radial surface; and
a pair of ring gears, symmetrically disposed on opposing sides of the rotor, each ring gear affixed to an inside face of one of the side covers, each of the ring gears having a plurality of teeth circumferentially disposed around an inner radial surface of each of the ring gears, and configured to engage with the teeth of a corresponding one of the pinion gear segments.

2. The improved rotary engine of claim 1, wherein the teeth of the first and second segments of the pinion gear are crowned.

3. The improved rotary engine of claim 1, wherein the teeth of each of the ring gears are crowned.

4. The improved rotary engine of claim 1, wherein each of the ring gears includes a flexible thin continuous rim around its outer circumference.

5. The improved rotary engine of claim 1, wherein the pinion gear is coupled to the output shaft by a first bearing.

6. The improved rotary engine of claim 5, wherein the first bearing is a hydrodynamic bearing.

7. The improved rotary engine of claim 1, wherein each ring gear is affixed to the inside face of one of the side covers by a spring pin.

8. The improved rotary engine of claim 1, wherein the output shaft extends through each of the pair of side covers.

9. The improved rotary engine of claim 8, wherein each of the pair of side covers is coupled to the output shaft by a second bearing.

10. The improved rotary engine of claim 9, wherein the second bearing is a hydrodynamic bearing.

11. The improved rotary engine of claim 1, wherein an inner axial face of each of the ring gears comprises a groove and a series of pad cutouts disposed circumferentially around at least a portion of a circumference of the inner axial face of each of the ring gears.

12. The improved rotary engine of claim 11, wherein the groove and the series of pad cutouts are disposed circumferentially around an entire circumference of the inner axial face of each of the ring gears.
